(19) United States
(12) Patent Application Publication
(10) Pub. No.: US 2012/0002209 A1
(43) Pub. Date: Jan. 5, 2012

(54) HIV/AIDS Treatment Efficacy Measure

(76) Inventor: Satish Deshpande, Guelph, CA (US)

(21) Appl. No.: 13/199,638

(22) Filed: Sep. 6, 2011

Related U.S. Application Data
(63) Continuation-in-part of application No. 12/703,820, filed on Feb. 11, 2010.
Application No. 12/703,820 is a continuation-in-part of application No. 11/767,665, filed on Jun. 25, 2007, now abandoned.
Application No. 11/767,665 is a continuation-in-part of application No. 11/611,880, filed on Dec. 17, 2006, now abandoned.
Application No. 11/611,880 is a continuation of application No. 10/416,099, filed on May 6, 2003, now abandoned.
(60) Provisional application No. 60/265,761, filed on Feb. 1, 2001.

(51) Int. Cl. G01N 21/55

(52) U.S. Cl. 356/448

(57) ABSTRACT

A white blood cell nuclei light scattering peak resolving process measures efficacies of treatment agents against an HIV/AIDS infection of a person by calculating changes between Mie scatterings from blood from the person and from blood from the person with a treatment agent added, where the Mie scatterings resolve the first Mie light scattering peak of white blood cell nuclei.

This application is a continuation in part of co-pending U.S. application Ser. No. 12/703,820 filed 11 Feb. 2010 which is incorporated in full herein by reference.

Which application is a continuation in part of U.S. application Ser. No. 11/767,665 filed 25 Jun. 2007 and published as US2007/0292942A1 on 20 Dec. 2007 which is incorporated in full herein by reference.

Which application is a continuation in part of U.S. application Ser. No. 11/611,880 filed 17 Dec. 2006 and published as US2007/0105088 on 10 May 2007 which is incorporated in full herein by reference.

Which application is a continuation of U.S. application Ser. No. 10/416,099 filed 06 May 2003 and published as US2004/0043433 on 4 Mar. 2004 which is incorporated in full herein by reference.

Which application is a 371 of PCT application PCT/US02/021322 filed 25 Jan. 2002 and published as WO02/077748 on 3 Oct. 2002 which is incorporated in full herein by reference.

Which application claims priority of U.S. provisional application 60/265,761 filed 01 Feb. 2001; which is incorporated in full herein by reference.

A white blood cell nuclei light scattering peak resolving process for measuring efficacies of treatments against an HIV/AIDS infection of a person is at least as sensitive and reliable as other best practice genotyping and phenotyping.

It is a new result, and unexpected discovery, that calculations of light scattering changes in HIV/AIDS infected white blood cells caused by treatment agents do measure efficacies of treatment agents against an HIV/AIDS infection of a person at least as sensitively and reliably as other best practice genotyping and phenotyping.

This white blood cell nuclei light scattering peak resolving process can produce results within an hour and takes only a few easy-to-calibrate steps. Best practice genotyping and phenotyping take more than ten times as long and require many steps which require meticulous calibration.

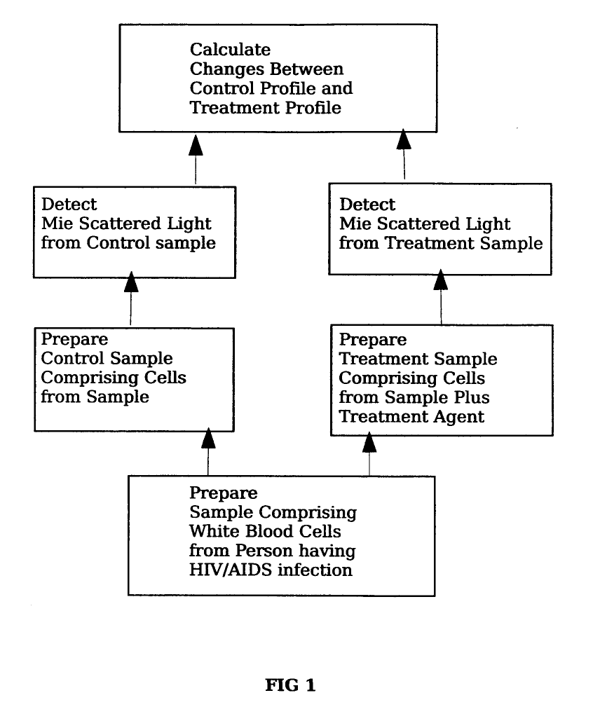

FIG. 1 schematically shows steps of the process.

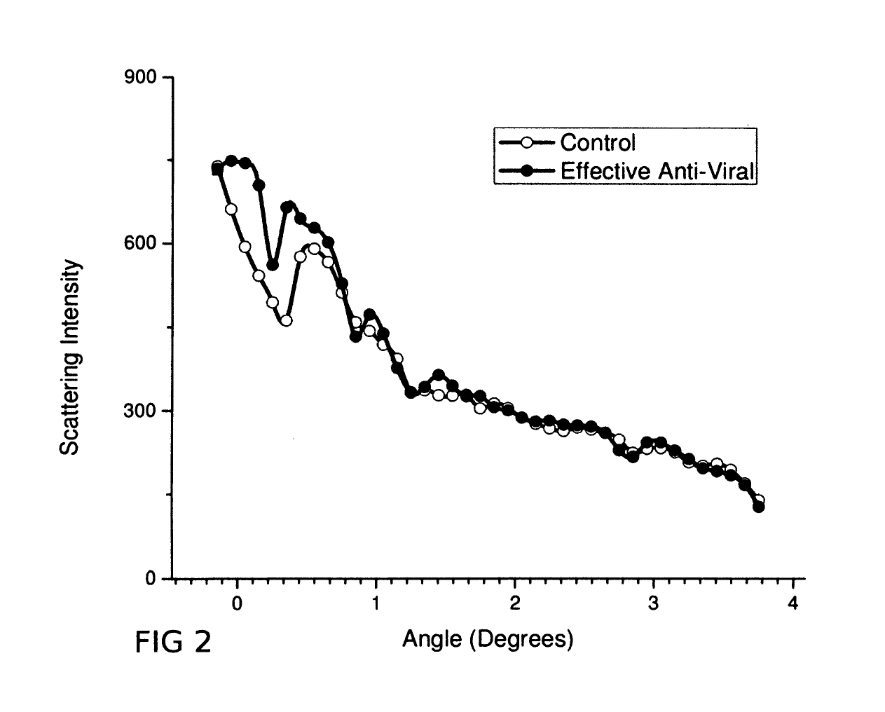

FIG. 2 shows an example of comparison of control profile (open circles) and corresponding treatment profile (solid circles) for an effective treatment. Note that the data density (intensity data for each tenth degree) here and in the subsequent figure is sufficient to resolve the light scattering peak just before one degree.

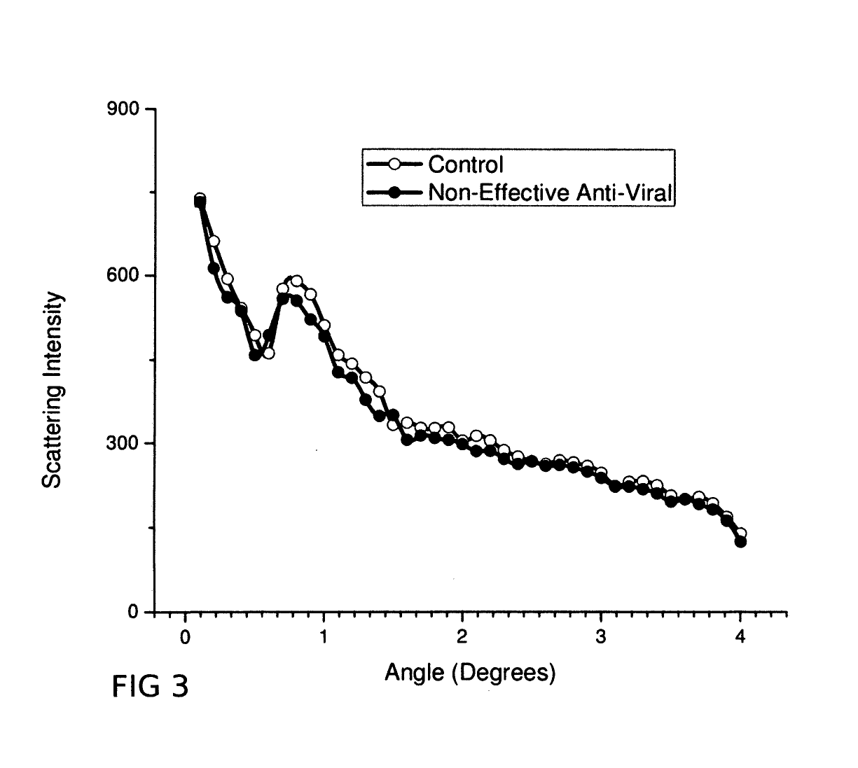

FIG. 3 shows an example of comparison of control profile (open circles) and corresponding treatment profile (solid circles) for an ineffective treatment.

The preparing and detecting steps shown schematically in FIG. 1 are optimized for light scattering by white blood cell nuclei so that a first white blood cell nuclei light scattering peak is resolved as shown in FIG. 2 and FIG. 3.

There are several ways that the light scattering optimized for here is distinct from, and very different from, inelastic scatterings, flow cytometery scatterings from single cells typically with fluorescent markers added, and turbidimetric scattering measurements at large angles.

First, for light wavelengths between 750 nm and 1,000 nm, scattering by an ensemble comprising white blood cells is well approximated by the Mie solutions of Maxwell's equations, throughout here called Mie light scattering for simplicity.

Second, this observed Mie light scattering by white blood cell nuclei in an ensemble comprising white blood cells is from fluctuations of electric dipole moment orientations of white blood cell nuclei.

Third, for scattering by white blood cell nuclei these fluctuations are maximally additive to produce a first Mie light scattering peak for white blood cell nuclei between zero and two degrees away from the central ray of incident light. The position of this peak varies with incident light wavelength, index of refraction, and persons' white blood cells.

There are many secondary Mie light scattering peaks at larger angles and much lower intensities. Because all these many secondary scattering peaks are superimposed it is very difficult to reliably extract information outside the angular range containing the first Mie light scattering peaks of white blood cells.

Changes between a control profile and a treatment profile—seen in FIG. 2 for example—can be caused by changes in size and shape of scatterers and can be caused by changes in index of refraction of scatterers and of the medium and can be caused by loss of scatterers. All of these factors are subject to random variations.

It is a new result, and unexpected discovery, that changes in Mie light scattering in HIV/AIDS infected white blood cells caused by treatment agents are reliably and sensitively greater than random variations in the Mie light scattering.

A white blood cell nuclei light scattering peak resolving process provides measures of efficacy of treatment agents, and combinations of treatment agents, against the specific HIV/AIDS infection of a specific person providing a blood sample.

A white blood cell nuclei light scattering peak resolving process for measuring HIV/AIDS treatment efficacies for specific HIV/AIDS infections of specific persons comprises:
1) sample preparing of a sample,
2) control preparing of a control sample,
3) treatment preparing of a treatment sample,
4) control detecting of a control profile,
5) treatment detecting of a treatment profile, and
6) calculating differences between the control profile and the treatment profile.

The sample preparing step comprises sample preparing a sample comprising whole blood cells from a person having an HIV/AIDS infection, the sample having a detection optimized concentration such that the sample has at least a resolvable first Mie light scattering peak of white blood cell nuclei.

The sample preparing step can also comprise the sub-step of separating white blood cells from whole blood so that the sample comprises white blood cells without red blood cells.

The control preparing step comprises control preparing a control sample comprising a control ensemble of cells from the sample.

The treatment preparing step comprises treatment preparing of a treatment sample comprising a treatment ensemble of cells from the sample with at least one treatment agent added.

The control detecting step comprises control detecting of a control profile comprising a control angular distribution of intensities of control light which is Mie scattered from the control ensemble, resolving at least the first Mie light scattering peak of white blood cell nuclei.

The control detecting step can also comprise second control detecting of a second control profile comprising a second control angular distribution of intensities of second control light which is Mie scattered from the control ensemble, resolving at least the Mie light scattering peak of white blood cell nuclei, the second control light having a wavelength different from the control light, changes between the control profile and the second control profile other than changes due to the wavelength difference measuring contamination of the sample.

The treatment detecting step comprises treatment detecting of a treatment profile comprising a treatment angular distribution of intensities of treatment light which is Mie scattered from the treatment ensemble, resolving at least the Mie light scattering peak of white blood cell nuclei.

Control light and treatment light can be from multiple sources and can be from one source alternately illuminating the control sample and the treatment sample.

The calculating step comprises calculating changes between the control profile and the treatment profile.

The calculating step can comprise calculating correlation between control profile scattered light intensities and the treatment profile scattered light intensities by calculating Pearson's product moment correlation coefficient for the control profile scattered light intensities and the treatment profile scattered light intensities.

Calculating can mean any of various statistical techniques, which reliably distinguish between changes caused by the treatment agent and random changes. Pearson's product moment correlation coefficient, for example, works well.

Calculating can mean presentation of superimposed control profile data and treatment profile data for visual inspection of control profile data and treatment profile data as in FIG. 2 and FIG. 3.

Calculating can mean summing the absolute values of the intensity differences data-point-by-data-point over an angular region of interest such as over the zero to four degrees range shown in FIG. 2 and FIG. 3. This sum is the net area between the two curves.

Calculating can mean measuring the intensity difference at one key angle—and alternatively at more than one key angle.

Calculating can mean combination of more than one measurement alternative.

Calculating can cover an angular range which is a portion of a zero to four degrees range and which could be greater than the zero to four degrees range.

The calculating step can be automated using software means well known in the art.

Changes between the control profile and the second control profile, measuring contamination of the sample, can be calculated in the same ways just discussed for the calculating step, after the control profile and the second control profile data are calibrated for changes due to the wavelength difference.

Detecting a control profile is detecting an angular distribution of intensities of control light which is Mie scattered by a control ensemble into an angular region with a sufficient data density to resolve the first Mie scattered peak of white blood cell nuclei as seen in FIG. 2 and FIG. 3.

Detecting a treatment profile is detecting an angular distribution of intensities of light which is Mie scattered by a treatment ensemble into an angular region with a sufficient data density to resolve the Mie scattered peak of white blood cell nuclei as seen in FIG. 2 and FIG. 3.

For the detecting steps, accumulation of 100 to 500 exposures by a CMOS CCD sensor with 640×480 pixels per inch at a speed of 50 ms/exposure provides sensitive and reliable results. Other similar detectors and exposure accumulations can also give reliable results.

Either, and both, of the detecting steps can be done with two different wavelengths of light. Then, changes between the profiles from the different wavelengths, other than changes due to the wavelength difference alone, measure contamination of the sample, thereby improving reliability of the new process.

These detecting steps can be automated in an easy-to-calibrate device by means well known in the art.

Sample preparing the sample means buffering whole blood from a person having an HIV/AIDS infection to a detection optimized concentration so that the sample has at least a resolvable first Mie light scattering peak of white blood cell nuclei. This is a concentration which provides enough white blood cell nuclei scatterers along the path of light being scattered so that the peak is obtained, but not so many white blood cell nuclei scatterers so that the peak is broadened by multiple scatterings from white blood cell nuclei. For a light path two millimeters long through the control sample, and through the treatment sample, nine parts buffer to one part whole blood works well. The same buffering works for white blood cells separated from whole blood.

For a sample of whole blood buffered by Phosphate buffered saline (PBS) to nine parts buffer to one part cells, with a light path length of 2 mm, and for laser light of wavelength 780 nm, the first Mie light scattering peak of white blood cell nuclei occurs in the range 0.5 to 1.2 degrees away from the incident light central ray. Other useful scattering peaks occur in the range 1.2 to 1.4 degrees away from the incident light central ray and at angles greater than 1.4 degrees but less than 4 degrees. The peaks depend on the person's specific distribution of blood cell types and specific HIV/AIDS infection. Measurements of intensities at each tenth of a degree over a range including these peaks do resolve the scattering peaks and do provide for sensitive and reliable comparisons between a control sample profile and treatment sample profile.

Other similar buffers, other similar concentrations, other similar angular ranges, and other similar data densities can produce similar results.

The sample can comprise white blood cells separated from the whole blood.

Control preparing a control sample is just putting enough of the sample into the light path as is needed for detecting the control profile.

Treatment preparing a treatment sample is just putting enough of the sample and a treatment agent into the light path as is needed for detecting the treatment profile.

A control sample can comprise cells from the sample plus at least a first treatment agent added. A corresponding treatment sample would comprise cells from the sample with all the treatment agents in the control sample added and with a treatment agent not in the control sample added. This allows testing of combinations of treatment agents. Combinations of treatment agents can be more effective then constituent treatment agents alone and can be less effective then constituent treatment agents alone. These combination treatment efficacies are reliably and sensitively measured by this white blood cell light scattering peak resolving process.

It is a new result, and unexpected discovery, that these easily preformed, easily calibrated, easily automated preparing steps, and the easily preformed, easily calibrated, easily automated detecting and calculating steps produce measures of efficacy of treatments, and combinations of treatments, against the specific HIV/AIDS infection of a person, measures at least as sensitive and reliable as other best practice.

Claimed is:

1. A white blood cell nuclei light scattering peak resolving process for measuring HIV/AIDS treatment efficacies for specific HIV/AIDS infections of specific persons, the process comprising the steps:
sample preparing of a sample comprising whole blood from a person having an HIV/AIDS infection, the sample having a detection optimized concentration such that the sample has at least a resolvable first Mie light scattering peak of white blood cell nuclei;
control preparing of a control sample comprising a control ensemble of cells from the sample;
treatment preparing of a treatment sample comprising a treatment ensemble of cells from the sample with at least one treatment agent added;
control detecting of a control profile comprising a control angular distribution of intensities of control light which is Mie scattered from the control ensemble, resolving at least the first Mie light scattering peak of white blood cell nuclei;
treatment detecting of a treatment profile comprising a treatment angular distribution of intensities of treatment light which is Mie scattered from the treatment ensemble, resolving at least the first Mie light scattering peak of white blood cell nuclei; and
calculating changes between the control profile and the treatment profile.

2. The process of claim 1 wherein the sample preparing step also comprises the sub-step of separating white blood cells from whole blood so that the sample comprises white blood cells without red blood cells.

3. The process of claim 1 wherein the calculating step comprises calculating correlation between control profile scattered light intensities and the treatment profile scattered light intensities by calculating Pearson's product moment correlation coefficient for the control profile scattered light intensities and the treatment profile scattered light intensities

4. The process of claim 1 wherein the control detecting step also comprises second control detecting of a second control profile comprising a second control angular distribution of intensities of second control light which is Mie scattered from the control ensemble, resolving at least the Mie light scattering peak of white blood cell nuclei, the second control light having a wavelength different from the control light, changes between the control profile and the second control profile other than changes due to the wavelength difference measuring contamination of the sample.

5. A white blood cell nuclei light scattering peak resolving process for measuring HIV/AIDS treatment efficacies for specific HIV/AIDS infections of specific persons, the process comprising the steps:
sample preparing of a sample comprising separating white blood cells from whole blood from a person having an HIV/AIDS infection so that the sample comprises white blood cells without red blood cells, the having a detection optimized concentration such that the sample has at least a resolvable first Mie light scattering peak of white blood cell nuclei;
control preparing of a control sample comprising a control ensemble of cells from the sample;
treatment preparing of a treatment sample comprising a treatment ensemble of cells from the sample with at least one treatment agent agent added;
control detecting of a control profile comprising a control angular distribution of intensities of control light which is Mie scattered from the control ensemble, resolving at least the first Mie light scattering peak of white blood cell nuclei;
treatment detecting of a treatment profile comprising a treatment angular distribution of intensities of treatment light which is Mie scattered from the treatment ensemble, resolving at least the first Mie light scattering peak of white blood cell nuclei; and
calculating calculating correlation between control profile scattered light intensities and the treatment profile scattered light intensities by calculating Pearson's product moment correlation coefficient for the control profile scattered light intensities and the treatment profile scattered light intensities

6. The process of claim 5 wherein the control detecting step also comprises second control detecting of a second control profile comprising a second control angular distribution of intensities of second control light which is Mie scattered from the control ensemble, resolving at least the Mie light scattering peak of white blood cell nuclei, the second control light having a wavelength different from the control light, changes between the control profile and the second control profile other than changes due to the wavelength difference measuring contamination of the sample.

7. A white blood cell nuclei light scattering peak resolving process for measuring HIV/AIDS treatment efficacies for specific HIV/AIDS infections of specific persons, the process comprising the steps:
sample preparing of a sample comprising separating white blood cells from whole blood from a person having an HIV/AIDS infection so that the sample comprises white blood cells without red blood cells, the sample having a detection optimized concentration the sample having a detection optimized concentration such that the sample has at least a resolvable first Mie light scattering peak of white blood cell nuclei;
control preparing of a control sample comprising a control ensemble of cells from the sample;
treatment preparing of a treatment sample comprising a treatment ensemble of cells from the sample with at least one treatment agent agent added;
control detecting of a first control profile comprising a control angular distribution of intensities of control light which is Mie scattered from the control ensemble, resolving at least the first Mie light scattering peak of white blood cell nuclei and second control detecting of a second control profile comprising a second control angular distribution of intensities of second control light which is Mie scattered from the control ensemble resolving at least the first Mie light scattering peak of white blood cell nuclei, the second control light having a wavelength different from the control light, changes between the control profile and the second control profile other than changes due to the wavelength difference measuring contamination of the sample;
treatment detecting of a treatment profile comprising a treatment angular distribution of intensities of treatment light which is Mie scattered from the treatment ensemble, resolving at least the first Mie light scattering peak of white blood cell nuclei; and
calculating correlation between control profile scattered light intensities and the treatment profile scattered light intensities by calculating Pearson's product moment correlation coefficient for the control profile scattered light intensities and the treatment profile scattered light intensities.
